(19) United States
(12) Patent Application Publication
(10) Pub. No.: US 2026/0175693 A1
(43) Pub. Date: Jun. 25, 2026

(54) MONITORING SYSTEM FOR ENABLING REMOTE SHIFTING OF RANGE SELECTOR INTO NEUTRAL AND/OR RELEASE OF ELECTRONIC PARKING BRAKE

(71) Applicant: GM GLOBAL TECHNOLOGY OPERATIONS LLC, Detroit, MI (US)

(72) Inventors: Hyunwoo LEE, Bucheon-si (KR); Hyungjun KIM, Seoul (KR); Sundaresan BALASUBRAMANIAN, Lake Orion, MI (US); Joonhyoung PARK, Incheon (KR); Seokju YONG, Bucheon-si (KR)

(21) Appl. No.: 18/988,048

(22) Filed: Dec. 19, 2024

(51) Int. Cl. B60L 3/00; B60T 7/12

(52) U.S. Cl. CPC B60L 3/0046; B60T 7/12; B60L 2240/545; B60L 2240/622; B60Y 2400/302; B60Y 2400/902

(57) ABSTRACT

A vehicle includes a controller is configured to selectively control an electronic range selector and an electronic parking brake. A battery management system is configured to wake in response to receiving a first signal from a thermal relay, and cause a first wireless message identifying an active fire event, the vehicle, and a location of the vehicle to be sent using a wireless transceiver to at least one device associated with a vehicle owner, a manufacturer, and emergency personnel. The wireless transceiver is configured to receive a second wireless message using the wireless transceiver from the at least one device associated with the vehicle owner, the manufacturer, and the emergency personnel. The controller is configured to at least one of shift the electronic range selector to neutral and release the electronic parking brake in response to the second wireless message.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicles including a battery pack, and more particularly to a fire monitoring system configured to remotely shift a vehicle into neutral and/or release an electronic parking brake.

Vehicles such as battery electric vehicles, fuel cell vehicles, and/or hybrid vehicles may include a rechargeable energy storage system (RESS) including a battery pack. The battery pack includes one or more battery modules each including multiple battery cells.

### SUMMARY

A vehicle comprising a global positioning system configured to identify a location of the vehicle. An electronic range selector is configured to select one of park, reverse, drive, and neutral. The vehicle includes an electronic parking brake, a battery pack, a thermal relay configured to generate a first signal in response to a temperature of the battery pack being greater than or equal to a predetermined temperature, and a wireless transceiver. A controller is configured to selectively control the electronic range selector and the electronic parking brake. A battery management system is configured to wake in response to receiving the first signal from the thermal relay, and cause a first wireless message identifying an active fire event, the vehicle, and the location of the vehicle to be sent using the wireless transceiver to at least one device associated with a vehicle owner, a manufacturer, and emergency personnel. The wireless transceiver is configured to receive a second wireless message using the wireless transceiver from the at least one device associated with the vehicle owner, the manufacturer, and the emergency personnel. The controller is configured to at least one of shift the electronic range selector to neutral and release the electronic parking brake in response to the second wireless message.

In other features, the battery management system is configured to confirm that an active fire event is occurring before transmitting the first wireless message. The battery pack includes a temperature sensor, and the battery management system is configured to confirm that the active fire event is occurring in response to a temperature sensed by the temperature sensor being greater than a predetermined temperature.

In other features, the vehicle includes a telematics system including the wireless transceiver. The battery management system is configured to at least one of shift the vehicle into park using the electronic range selector and set the electronic parking brake in response to receiving a third wireless message from the wireless transceiver.

In other features, wherein the battery management system is configured to open a window in response to the second wireless message. The battery managements system is configured to open a sunroof in response to the second wireless message.

In other features, an inertial measurement unit configured to sense a longitudinal pitch of the vehicle. The battery management system is configured to confirm that an absolute value of the longitudinal pitch is less than a predetermined angle before transmitting the first wireless message.

In other features, the battery management system is configured to flash a hazard light in response to the battery management system confirming the active fire event. The battery management system is configured to flash the hazard lights in response to the battery management system confirming the active fire event and the longitudinal pitch being less than the predetermined angle.

A vehicle comprises an electronic range selector configured to select one of park, reverse, drive, and neutral, an electronic parking brake, a battery pack including a temperature sensor configured to monitor a temperature of the battery pack, a thermal relay configured to generate a first signal in response to a temperature of the battery pack being greater than or equal to a predetermined temperature, and a wireless transceiver. A controller is configured to selectively control the electronic parking brake and the electronic range selector. A battery management system is configured to wake in response to receiving the first signal from the thermal relay, confirm that an active fire event is occurring in response to a temperature sensed by the temperature sensor being greater than a predetermined temperature, cause the wireless transceiver to transmit a first wireless message using the wireless transceiver identifying the active fire event to at least one device associated with a vehicle owner, a manufacturer, and emergency personnel if the active fire event is confirmed.

The wireless transceiver is configured to receive a second wireless message from the at least one device associated with the vehicle owner, the manufacturer, and the emergency personnel. The controller is configured to at least one of shift the electronic range selector to neutral and release the electronic parking brake in response to the second wireless message.

In other features, the vehicle includes a telematics system including the wireless transceiver. The controller is configured to at least one of shift the electronic range selector and set the electronic parking brake in response to the wireless transceiver receiving a third wireless message.

In other features, the vehicle includes at least one of a window and a sunroof. The controller is configured to open the at least one of the window and the sunroof in response to the second wireless message.

In other features, an inertial measurement unit is configured to sense a longitudinal pitch of the vehicle. The controller is configured to confirm that an absolute value of the longitudinal pitch is less than a predetermined angle before the wireless transceiver transmits the first wireless message. The controller is configured to flash a hazard light in response to the battery management system confirming the active fire event and the longitudinal pitch being less than the predetermined angle.

A vehicle includes a window, an electronic range selector configured to select one of park, reverse, drive, and neutral, an electronic parking brake, an inertial measurement unit configured to sense a longitudinal pitch of the vehicle, and a battery pack including a temperature sensor configured to monitor a temperature of the battery pack. A thermal relay is configured to generate a first signal in response to a temperature of the battery pack being greater than or equal to a predetermined temperature. The vehicle includes a wireless transceiver and a controller configured to selectively control the electronic parking brake and the electronic range selector. A battery management system is configured to wake in response to receiving the first signal from the thermal relay, confirm that an active fire event is occurring in response to a temperature sensed by the temperature sensor being greater than a predetermined temperature, and cause a first wireless message to be transmitted by the wireless transceiver to at least one device associated with a vehicle owner, a manufacturer, and emergency personnel in response to confirmation of the active fire event and an absolute value of the longitudinal pitch is less than a predetermined angle. The wireless transceiver is configured to receive a second wireless message from the at least one device associated with the vehicle owner, the manufacturer, and the emergency personnel. The controller is configured to shift the electronic range selector to neutral, release the electronic parking brake, and open the window in response to the second wireless message.

In other features, the vehicle includes a telematics system including the wireless transceiver. The controller is configured to open the sunroof in response to the second wireless message. The controller is configured to flash a hazard light in response to the battery management system confirming the active fire event and the longitudinal pitch being less than the predetermined angle.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1A and 1B are examples illustrating a parking lot including a vehicle having an active fire event while surrounded by other vehicles;

FIG. 1C illustrates an example of a vehicle having an active fire event and covered by a fire tarp;

FIG. 1D illustrates an example of a vehicle having an active fire event and surrounded by a removeable water tank;

FIG. 2 is a functional block diagram of an example of a fire monitoring system for a vehicle according to the present disclosure;

FIGS. 3A and 3B illustrate operation of a thermal relay of the fire monitoring system according to the present disclosure; and

FIGS. 4, 5A, and 5B are flowcharts illustrating examples of methods for monitoring the vehicle for increased heat, confirming a fire event, and enabling shift to neutral and/or releasing an electronic parking brake remotely to facilitate movement of the vehicle according to the present disclosure.

In the drawings, reference numbers may be reused to identify similar and/or identical elements.

### DETAILED DESCRIPTION

Vehicles such as battery electric vehicles, fuel cell vehicles, and/or hybrid vehicles may include a rechargeable energy storage system (RESS) including a battery pack. The battery pack includes one or more battery modules each including multiple battery cells.

Vehicles may be parked in parking lots adjacent to other vehicles and/or the parking lot may be located inside or below a building. When one or more battery cells of a battery pack experience a malfunction, the temperature of the one or more battery cells increases. During a thermal runaway event, the increased heat from the one or more battery cells increases heating of other battery cells. Eventually, the other battery cells also fail and cause further heat propagation. The battery pack may eventually ignite (an active fire event) and cause damage to the vehicle and/or other vehicles or structures located nearby.

When the vehicle that is experiencing battery failure is located in a parking lot adjacent to other vehicles and/or inside a parking structure, it would help if the vehicle could be moved away from other vehicles to mitigate damage to the vehicle and/or collateral damage. When the vehicle is parked, the doors of the vehicle are typically locked and the windows and/or sunroof are typically closed. In addition to the range selector being in park, the vehicle may include an electronic parking brake that is engaged. As a result, the wheels of the vehicle are prevented from rotating and it is difficult to move the vehicle.

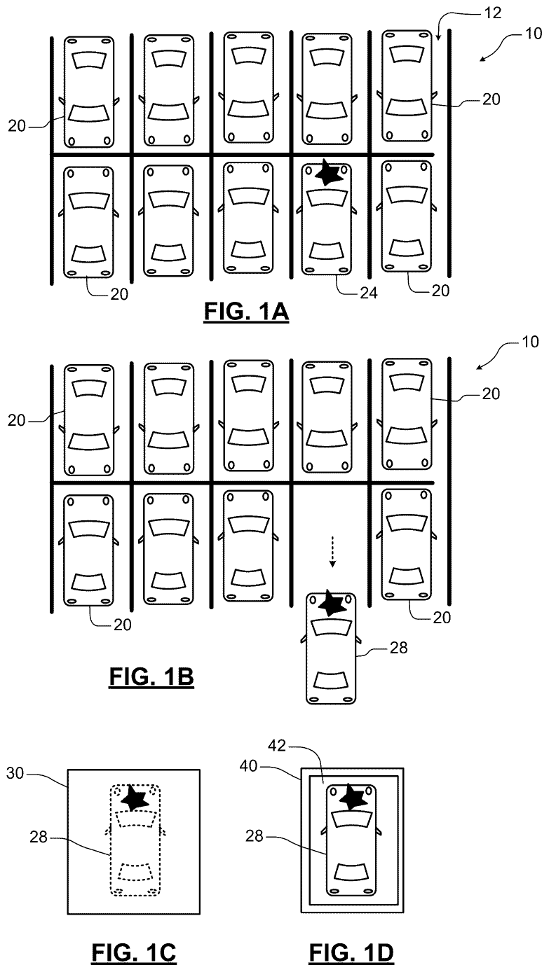

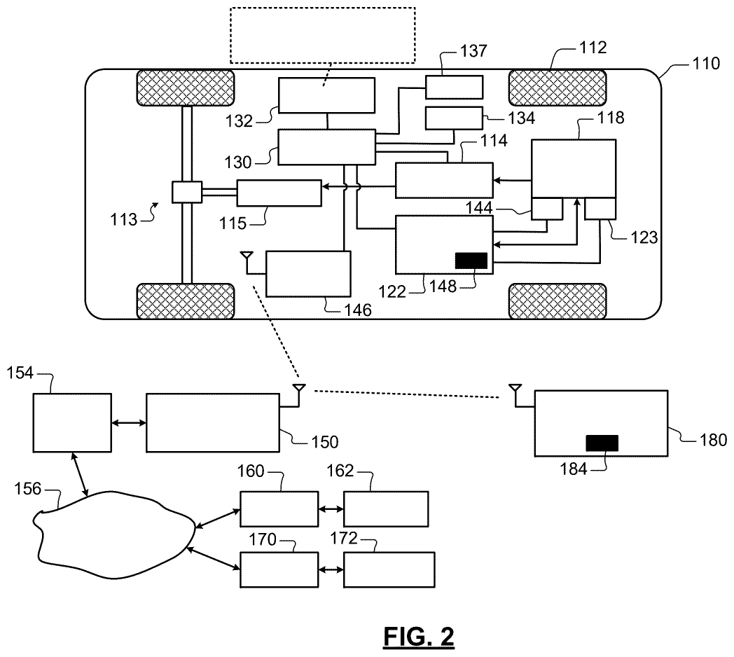

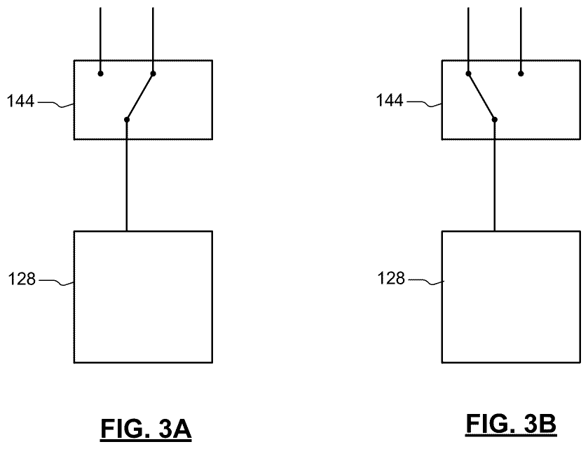

Referring now to FIGS. 1A and 1B, a parking lot 10 includes adjacent parking spots 12 for parking of vehicles 20. In FIG. 1A, a battery pack of a vehicle 24 experiences a malfunction and battery cells of the vehicle begin heating. Current battery management systems (BMS) do not typically monitor the temperature of the battery pack when the vehicle is off and in a sleep state.

The temperature of the battery pack continues to increase and eventually an active fire event occurs. As can be appreciated, the fire may damage the vehicles 20 located nearby and/or a building structure (if parked inside). Further, it can be difficult for fire personnel to move the vehicle since the range selector of the vehicle is in park and/or the electronic parking brake is engaged. It is difficult for fire personnel to mitigate damage to the vehicle and collateral damage given the small amount of space that may be available between the vehicle 24 and the surrounding vehicles 20 and/or building structures.

In FIG. 1B, a vehicle 28 includes a fire monitoring system according to the present disclosure. When one or more battery cells of the battery system of the vehicle 28 start to malfunction, the temperature of the battery pack increases. A thermal relay described further below senses the increase in temperature and wakes up a battery monitoring system.

The battery monitoring system monitors additional sensors associated with the battery management system to confirm whether an active fire event is occurring. If the active fire event is occurring, the battery monitoring system sends an active fire message to the manufacturer, an emergency service such as a fire department, and/or the owner of the vehicle. In some examples, the active fire message identifies that an active fire event is occurring, details relating to the vehicle, and/or the location of the vehicle. If the vehicle is parked on a relatively flat surface, the manufacturer, the emergency service personnel, and/or the owner can request that the vehicle shift to neutral, release the electronic parking brake, and/or open windows/sunroof of the vehicle. The fire monitoring system allows the vehicle to be moved which makes it easier to mitigate damage to the vehicle and/or collateral damage to adjacent vehicles and/or building structures located in the vicinity of the vehicle 28 during a fire event.

Referring now to FIGS. 1C and 1D, allowing the vehicle to be moved makes it easier for some types of fire mitigating measures to be implemented and/or mitigates damage to other vehicles and/or property. In addition, the thermal relay provides an earlier warning of the active fire event as the temperature of the battery pack increases and is sensed by the thermal relay (which may be the fire can be seen from outside of the vehicle).

For example in FIG. 1C, the vehicle 28 is moved forward from the parking spot 12 and then covered by a fire tarp 30 to arrest the fire and/or prevent the fire from damaging other vehicles and/or building structures. For example in FIG. 1D, the vehicle 28 is moved forward from the parking spot 12 and then surrounded by walls 40 that form a tank that can be filled with a fluid 42 such as water or other fire suppressing fluid to stop the fire and/or prevent the fire from damaging other vehicles and/or building structures.

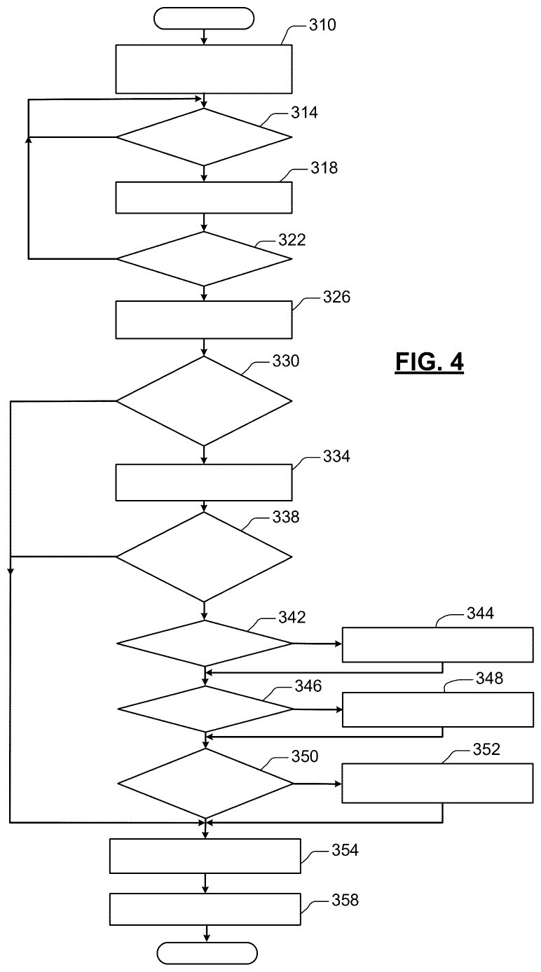

Referring now to FIG. 2, a fire monitoring system for a vehicle 110 is shown. The vehicle includes wheels 112 driven by an electric machine (EM) 115 via a drivetrain 113. A power inverter 114 selectively supplies power from a battery pack 118 to the electric machine 115 during propulsion and/or supplies power from the electric machine 115 to the battery pack 118 during regeneration.

The vehicle 110 further includes a battery management system 122 configured to monitor the battery pack 118. The battery management system 122 includes one or more sensors 123 configured to monitor parameters (voltage, current, resistance, temperature, etc.) of the battery pack 118. One or more other vehicle controllers 130 are configured to control other aspects of vehicle operation. The one or more vehicle controller 130 controls one or more actuators/devices 132 such as a drive selector (such as a park, reverse, neutral, drive (PRND) selector), an electronic parking brake, windows, a sunroof, etc.

The one or more vehicle controllers 130 receive one or more driver inputs from an accelerator, a brake pedal, and/or other actuators. For example, the one or more vehicle controllers 130 also receive data from an inertial measurement unit (IMU) 134 relating to yaw and/or longitudinal pitch of the vehicle 110 and/or vehicle location data from a global positioning system (GPS) 137 configured to determine a location of the vehicle. The one or more vehicle controllers 130 communicate with a wireless transceiver 146. In some examples, the wireless transceiver 146 forms part of a telematics system (such as OnStar® or other telematics system). The wireless transceiver 146 is configured to wirelessly communicate with a manufacturer, the owner, the Internet, an emergency services provider, etc. using any suitable wireless network such as a cellular network, satellite network, Bluetooth, or other suitable wireless network.

When the vehicle 110 is in a power off mode and a vehicle sleep state, a temperature of the battery pack 118 is monitored by a thermal relay 144. In some examples, the vehicle shuts down (or transitions to a stand-by mode) some or all of the vehicle controllers (including a battery management system) used during operation of the vehicle to conserve energy during the sleep state. In some examples, the thermal relay 144 includes a bimetallic strip. The battery management system 122 includes a fire monitoring module 148 configured to wake in response to an elevated temperature sensed by the thermal relay 144.

When the thermal relay is triggered, the battery management system 122 confirms that an active fire event is occurring using the sensors 123. The one or more vehicle controllers 130 or battery management system 122 confirms that the vehicle is parked on a relatively flat surface (e.g., to prevent problems that may arise if the drive selector is remotely moved to neutral and/or the electronic parking brake is released while parked on an incline). In some examples, the surface is considered relatively flat when the grade is less than or equal to 2% or 1%. The one or more vehicle controllers 130 or battery management system 122 alerts the manufacturer, the owner, and/or the emergency services provider that an active fire event is occurring. The manufacturer, the owner, and/or the emergency services provider can selectively request shifting the vehicle to neutral, releasing the electronic parking brake (EPB), and/or opening the windows and/or sunroof of the vehicle (e.g., using an express open command) to facilitate movement of the vehicle.

The wireless transceiver 146 wirelessly communicates via a wireless communication system 150 (e.g., cellular, satellite, Wi-Fi, Bluetooth, or other wireless network) to send the active fire message and/or to receive return messages including commands from the manufacturer, the owner, and/or the fire personnel. In some examples, the wireless communication system 150 communicates with a server 154 connected to a distributed communications system 156 such as the Internet. The distributed communications system 156 routes the message to a server 160 in communication with a manufacturer's system 162. A server 170 communicates with the distributed communications system 156 and a server 170 of an emergency services system 172.

In some examples, a wireless device 180 (such as a smartphone associated with the owner or the emergency responders) includes one or more applications 184 configured to receive active fire alert messages or broadcasts from the vehicle. The one or more applications 184 allow the owner or the emergency responder to respond to the active fire alert by requesting one or more actions such as shifting the vehicle to neutral, releasing the electronic parking brake (EPB), and/or opening the windows and/or sunroof of the vehicle.

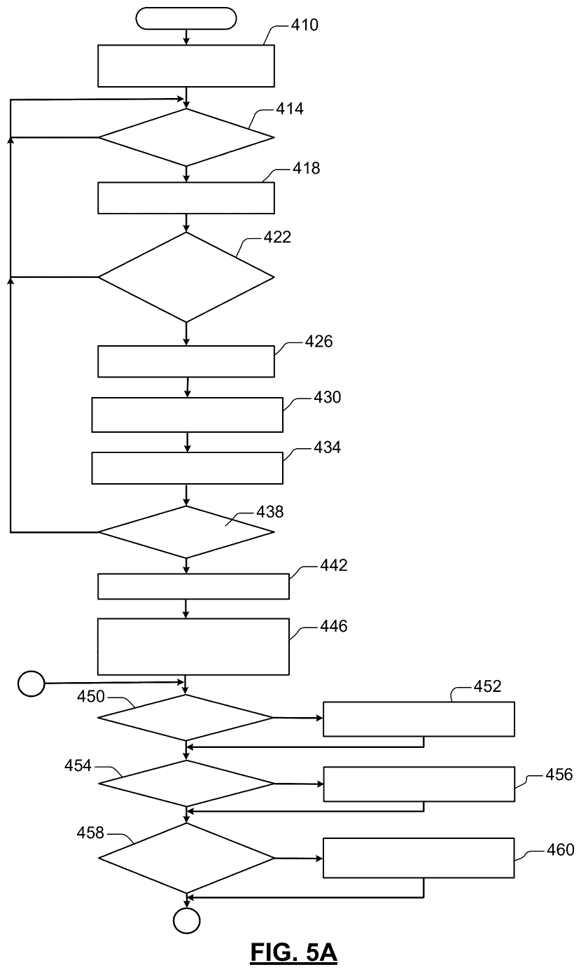

Referring now to FIGS. 3A and 3B, operation of the thermal relay 144 is shown. The thermal relay 144 receives power from a battery (e.g., an accessory battery) and ground. The thermal relay 144 is normally open. When the temperature of the thermal relay 144 increases greater than a predetermined temperature, the thermal relay 144 closes and supplies voltage to wake up the battery management system 128. When received, the battery management system 128 wakes up and performs battery diagnostics to confirm that an active fire event is occurring and to take other actions described below if the active fire event is confirmed.

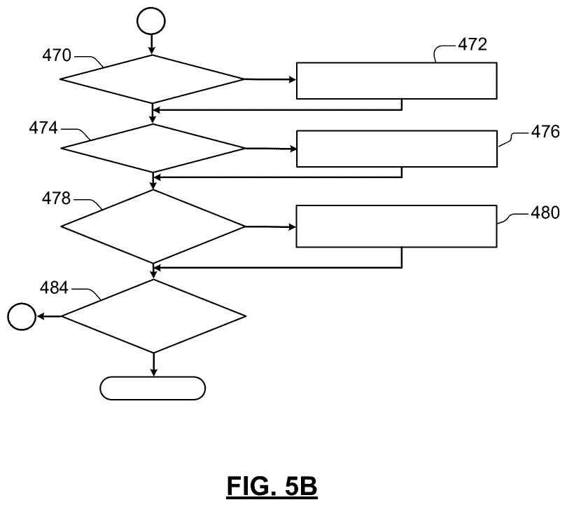

Referring now to FIG. 4, a method for monitoring the vehicle, shifting the vehicle to neutral, releasing the electronic parking brake, and/or opening the windows and/or sunroof in response to an active fire event is shown. At 310, the method determines whether one or more preconditions are met. In some examples, the preconditions include the vehicle is off and the drive selector is in park.

At 314, the method determines whether the thermal relay 144 has been triggered in response to increased temperature of the battery pack. If 314 is true, the method continues and wakes up the battery management system at 318. At 322, the battery management system 122 confirms an active fire event (e.g., the temperature of the battery pack 118 is greater than or equal to a predetermined threshold T_{TH1}). If 322 is true, the battery management system 122 wakes up other vehicle controllers such as the one or more vehicle controllers 130, the wireless transceiver 146, etc. At 330, the battery management system 122 determines whether the vehicle 110 is parked on a relatively flat surface (e.g., the absolute value of the longitudinal pitch of the vehicle≤predetermined angle (A_{TH1})). If 330 is true, the method sends an active fire message to the owner at 334.

At 338, the method determines whether the owner selects to move the drive selector to neutral, release the electronic parking brake (EPB), and/or open the windows and/or sunroof. If 338 is true, the battery management system 122 moves the vehicle 110 into neutral at 342 and 344, releases the electronic parking brake at 346 and 348, and/or opens the windows and/or sunroof at 350 and 352 (assuming the owner selects each of these actions or a single command can select all three). At 354, the method reports the active fire event to the manufacturer and/or reports the vehicle to emergency services such as fire personnel using the wireless transceiver 146.

Referring now to FIG. 5, another method for monitoring the vehicle, shifting the vehicle to neutral, releasing the electronic parking brake, and/or opening the windows and/or sunroof in response to the battery thermal event is shown. At 410, the method determines whether the one or more preconditions are met.

At 414, the method determines whether the thermal relay has been activated in response to an increased temperature of the battery pack. If 414 is true, the method continues at 418 and wakes up the battery management system 122. At 422, the battery management system 122 confirms that an active fire event is occurring (e.g., the temperature of the battery pack 118 is greater than or equal to a predetermined threshold T_{TH1}). If 422 is true, the battery management system 122 wakes up other vehicle controllers.

At 430 and 434, the method reports the active fire event to the manufacturer and/or reports the vehicle to emergency services such as fire personnel using the wireless transceiver 146. At 438, the battery management system determines whether the vehicle is parked on a flat surface (e.g., the absolute value of the longitudinal pitch of the vehicle≤predetermined angle (A_{TH1})).

If 438 is true, the method flashes hazard lights of the vehicle at 442 to indicate that the vehicle is ready to be moved. At 446, the vehicle broadcasts a message for a predetermined period using the telematics system and/or Wi-Fi of the vehicle. The owner or fire personnel can selectively respond to the broadcast message by requesting shifting the drive selector to neutral at 450 and 452, releasing the electronic parking brake at 454 and 456, and/or opening the windows/sunroof at 458 and 460 (or optionally a single command initiates all three actions).

After moving the vehicle, the vehicle can be moved into park and the electronic parking brake can be engaged using a similar approach. The owner or fire personnel can selectively request shifting the drive selector to park at 470 and 472, engaging the electronic parking brake at 474 and 476, and/or opening the windows and/or sunroof at 478 and 480 (or optionally a single command initiates all three actions). At 484, the method determines whether the fire event is over. If 484 is true, the method ends. If 484 is false, the method returns to 450.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A vehicle comprising:
a global positioning system configured to identify a location of the vehicle;
an electronic range selector configured to select one of park, reverse, drive, and neutral;
an electronic parking brake;
a battery pack;
a thermal relay configured to generate a first signal in response to a temperature of the battery pack being greater than or equal to a predetermined temperature;
a wireless transceiver;
a controller configured to selectively control the electronic range selector and the electronic parking brake; and
a battery management system configured to:
wake in response to receiving the first signal from the thermal relay, and
cause a first wireless message identifying an active fire event, the vehicle, and the location of the vehicle to be sent using the wireless transceiver to at least one device associated with a vehicle owner, a manufacturer, and emergency personnel,
wherein the wireless transceiver is configured to receive a second wireless message using the wireless transceiver from the at least one device associated with the vehicle owner, the manufacturer, and the emergency personnel,
wherein the controller is configured to at least one of shift the electronic range selector to neutral and release the electronic parking brake in response to the second wireless message.

2. The vehicle of claim 1, wherein the battery management system is configured to confirm that an active fire event is occurring before transmitting the first wireless message.

3. The vehicle of claim 2, wherein:
the battery pack includes a temperature sensor, and
the battery management system is configured to confirm that the active fire event is occurring in response to a temperature sensed by the temperature sensor being greater than a predetermined temperature.

4. The vehicle of claim 1, wherein further comprising a telematics system including the wireless transceiver.

5. The vehicle of claim 1, wherein the battery management system is configured to at least one of shift the vehicle into park using the electronic range selector and set the electronic parking brake in response to receiving a third wireless message from the wireless transceiver.

6. The vehicle of claim 1, further comprising:
a window,
wherein the battery management system is configured to open the window in response to the second wireless message.

7. The vehicle of claim 1, further comprising:
a sunroof,
wherein the battery managements system is configured to open the sunroof in response to the second wireless message.

8. The vehicle of claim 1, further comprising:
an inertial measurement unit configured to sense a longitudinal pitch of the vehicle,
wherein the battery management system is configured to confirm that an absolute value of the longitudinal pitch is less than a predetermined angle before transmitting the first wireless message.

9. The vehicle of claim 1, further comprising:
a hazard light,
wherein the battery management system is configured to flash the hazard light in response to the battery management system confirming the active fire event.

10. The vehicle of claim 8, further comprising:
a hazard light,
wherein the battery management system is configured to flash the hazard light in response to the battery management system confirming the active fire event and the longitudinal pitch being less than the predetermined angle.

11. A vehicle comprising:
an electronic range selector configured to select one of park, reverse, drive, and neutral;
an electronic parking brake;
a battery pack including a temperature sensor configured to monitor a temperature of the battery pack;
a thermal relay configured to generate a first signal in response to a temperature of the battery pack being greater than or equal to a predetermined temperature;
a wireless transceiver;
a controller configured to selectively control the electronic parking brake and the electronic range selector; and
a battery management system configured to:
wake in response to receiving the first signal from the thermal relay,
confirm that an active fire event is occurring in response to a temperature sensed by the temperature sensor being greater than a predetermined temperature, and
cause the wireless transceiver to transmit a first wireless message using the wireless transceiver identifying the active fire event to at least one device associated with a vehicle owner, a manufacturer, and emergency personnel if the active fire event is confirmed,
wherein the wireless transceiver is configured to receive a second wireless message from the at least one device associated with the vehicle owner, the manufacturer, and the emergency personnel,
wherein controller is configured to at least one of shift the electronic range selector to neutral and release the electronic parking brake in response to the second wireless message.

12. The vehicle of claim 10, further comprising a telematics system including the wireless transceiver.

13. The vehicle of claim 10, wherein the controller is configured to at least one of shift the electronic range selector and set the electronic parking brake in response to the wireless transceiver receiving a third wireless message.

14. The vehicle of claim 10, further comprising:
at least one of a window and a sunroof,
wherein the controller is configured to open the at least one of the window and the sunroof in response to the second wireless message.

15. The vehicle of claim 10, further comprising:
an inertial measurement unit configured to sense a longitudinal pitch of the vehicle,
wherein the controller is configured to confirm that an absolute value of the longitudinal pitch is less than a predetermined angle before the wireless transceiver transmits the first wireless message.

16. The vehicle of claim 15, further comprising:
a hazard light,
wherein the controller is configured to flash the hazard light in response to the battery management system confirming the active fire event and the longitudinal pitch being less than the predetermined angle.

17. A vehicle comprising:
a window;
an electronic range selector configured to select one of park, reverse, drive, and neutral;
an electronic parking brake;
an inertial measurement unit configured to sense a longitudinal pitch of the vehicle,
a battery pack including a temperature sensor configured to monitor a temperature of the battery pack;
a thermal relay configured to generate a first signal in response to a temperature of the battery pack being greater than or equal to a predetermined temperature;
a wireless transceiver;
a controller configured to selectively control the electronic parking brake and the electronic range selector; and
a battery management system configured to:
wake in response to receiving the first signal from the thermal relay,
confirm that an active fire event is occurring in response to a temperature sensed by the temperature sensor being greater than a predetermined temperature, and
cause a first wireless message to be transmitted by the wireless transceiver to at least one device associated with a vehicle owner, a manufacturer, and emergency personnel in response to confirmation of the active fire event and an absolute value of the longitudinal pitch is less than a predetermined angle,
wherein the wireless transceiver is configured to receive a second wireless message from the at least one device associated with the vehicle owner, the manufacturer, and the emergency personnel,
wherein controller is configured to shift the electronic range selector to neutral, release the electronic parking brake, and open the window in response to the second wireless message.

18. The vehicle of claim 17, further comprising a telematics system including the wireless transceiver.

19. The vehicle of claim 18, further comprising:
a sunroof,
wherein the controller is configured to open the sunroof in response to the second wireless message.

20. The vehicle of claim 17, further comprising:
a hazard light,
wherein the controller is configured to flash the hazard light in response to the battery management system confirming the active fire event and the longitudinal pitch being less than the predetermined angle.
